(19) United States
(12) Patent Application Publication
(10) Pub. No.: US 2018/0158045 A1
(43) Pub. Date: Jun. 7, 2018

(54) SYSTEMS AND METHODS FOR SERVICES ENROLLMENT USING A MOBILE DEVICE

(71) Applicant: Capital One Services, LLC, McLean, VA (US)

(72) Inventor: Daniel LOOMIS, San Francisco, CA (US)

(73) Assignee: Capital One Services, LLC, McLean, VA (US)

(21) Appl. No.: 15/870,848

(22) Filed: Jan. 12, 2018

Related U.S. Application Data
(63) Continuation of application No. 14/977,262, filed on Dec. 21, 2015.
(60) Provisional application No. 62/095,335, filed on Dec. 22, 2014.

(51) Int. Cl. G06Q 20/32; G06Q 30/06; G06Q 20/10

(52) U.S. Cl. CPC G06Q 20/3278; G06Q 20/322; G06Q 20/10; G06Q 30/06

(57) ABSTRACT

A wireless device is enabled for services enrollment. The wireless device receives card data for a financial account card and stores the card data in a memory associated with the wireless device. The wireless device also receives consumer identification data associated with the financial account card and stores the consumer identification data in the memory associated with the wireless device. Responsive to using the card data in a transaction at a merchant, the wireless device receives transaction line-item data from a computing system associated with the merchant. The wireless device determines a service associated with the transaction based on the line-item data and initiates enrollment in the determined service using the consumer identification data.

### PRIORITY

This application claims priority to U.S. Provisional Application No. 62/095,335 filed Dec. 22, 2014, the disclosure of which is hereby incorporated by reference in its entirety.

### BACKGROUND

In a conventional credit card transaction, a credit card holder presents a financial account product, such as a credit/debit card, smartcard, digital wallet, etc., to a merchant. The merchant typically swipes a magnetic stripe on the card through a card reader or, for a smart card or digital wallet, places the smartcard or digital wallet near a radio frequency identification (RFID) device that is built into or attached to a point-of-sale (POS) terminal. The account information is then transmitted to the POS terminal, which in turn transmits the account information over a secure network. The account information is authenticated and ultimately used to authorize a transaction.

Often, when a good is purchased in a transaction, services related to that good are available to the consumer purchasing the good. These services, however, typically require the consumer to actively participate in an enrollment process to enlist in the offered services. For example, a consumer can purchase a good made by a manufacturer, and the manufacturer may offer a warranty on the good. To receive service or a replacement good under the terms of the warranty, the consumer typically must enroll in the manufacturer's warranty program within a prescribed time period of buying the good. Services related to the purchase of a good can also include insurance and maintenance plans associated with the good or service, for which the consumer can optionally enroll for free, upon payment of a fee, or in response to a promotion offered by the merchant selling the good.

Current computing systems and supporting infrastructures are ill-equipped to address these and similar issues. There is therefore a need for computing systems capable of quickly and efficiently enrolling customers in services related to the purchase of a good to which the customers are entitled.

### SUMMARY

Consistent with disclosed embodiments, a method is provided for service enrollment using a wireless device. The method includes receiving card data for a financial account card and storing the card data in a memory associated with the wireless device. The method further includes receiving consumer identification data associated with the financial account card and storing the consumer identification data in the memory associated with the wireless device. Responsive to using the card data in a transaction at a merchant, the method includes receiving transaction line-item data from a computing system associated with the merchant. The method also includes determining a service associated with the transaction based on the line-item data and initiating enrollment in the determined service using the consumer identification data.

Also, consistent with disclosed embodiments, a wireless device is described that receives card data for a financial account card and stores the card data in a memory associated with the wireless device. The wireless device also receives consumer identification data associated with the financial account card and stores the consumer identification data in the memory associated with the wireless device. Responsive to using the card data in a transaction at a merchant, the wireless device receives transaction line-item data from a computing system associated with the merchant. The wireless device determines a service associated with the transaction based on the line-item data and initiates enrollment in the determined service using the consumer identification data.

Further, a non-transitory computer readable medium is disclosed that stores instructions that cause one or more processors to perform operations. The operations include receiving card data for a financial account card and storing the card data in a memory associated with a wireless device. The operations further include receiving consumer identification data associated with the financial account card and storing the consumer identification data in the memory associated with the wireless device. Responsive to using the card data in a transaction at a merchant, the operations also include receiving transaction line-item data from a computing system associated with the merchant. The operations further include determining a service associated with the transaction based on the line-item data and initiating enrollment in the determined service using the consumer identification data.

It is to be understood that both the foregoing general description and the following detailed description are exemplary and explanatory only and are not intended as restrictive.

### BRIEF DESCRIPTION OF THE DRAWINGS

The accompanying drawings, which are incorporated in and constitute a part of this specification, illustrate embodiments consistent with the disclosure. In the drawings:

FIG. 1 shows exemplary computing systems connected via a network that can be configured to perform the operations of disclosed embodiments;

FIG. 2 is an exemplary block diagram of the components of a wireless device;

FIG. 3 is an exemplary flow diagram of a process for services enrollment;

FIG. 4 shows an exemplary flow diagram of a process for event notification;

FIG. 5 shows an exemplary wireless device including a card slot for inserting a financial account card;

FIG. 6 shows an example of a financial account card being inserted into the card slot of the wireless device shown in FIG. 5;

FIG. 7 is an exemplary diagram showing the interaction between a wireless device and a POS terminal; and

FIG. 8 is an exemplary menu of stored cards that is shown on a display of a wireless device.

### DESCRIPTION OF EMBODIMENTS

One problem with existing methods for enrolling consumers and their products in services related to those products is that consumers often have to manually complete registration cards or visit a website to enroll in the services. As a result, many consumers neglect to enroll in the services or choose not to do so. But, the use of wireless devices such as cellular phones provides a more interactive transaction experience than what is capable using a traditional financial account card with a magnetic stripe. As wireless devices include processors and memory and components for wireless communication with other computer systems, they can be configured to communicate with one or more merchant systems during a transaction. For example, during a transaction, a wireless device can receive information about the transaction, such as line-item transaction data describing the goods or services that are part of the transaction, or information about the merchant itself, such as the merchant's Merchant Category Code (MCC), name, address, or other descriptive information.

The ability for the wireless device and the merchant computing system, such as POS terminal, to communicate provides opportunity to simplify or improve the processing associated with enrollment for services related to a good purchased in a transaction. In addition, as wireless devices have access to personal information of the consumers that own or operate them, this personal information can be leveraged to ease the registration process. And, as wireless devices can store card data associated with one or more financial accounts, such card data can be used to purchase services associated with goods purchased at a merchant.

Another problem with existing methods for enrolling consumers and their products in services related to those products is that consumers are often unaware of the terms and conditions corresponding to the services. In some cases, a service for a good may only apply to certain functional aspects of the good and the service may only be available for particular time. For example, a warranty for a light emitting diode (LED) computer display may only apply to the performance of the individual LEDs of the display and not to the power supply of the display, or the replacement warranty for the individual LEDs of the display may last 2 years while the replacement warranty for the power supply may last 5 years. As consumers enroll goods in service programs, it can become difficult for the consumer to remember all of the terms and conditions for their service programs.

Yet another problem with existing methods for enrolling consumers and their products in services related to those products is that consumers are often unaware, or need to be reminded of, preventative maintenance activities that they can perform on the goods. In some cases, these preventative maintenance activities are a requirement of the service provided by the service provider. For example, a warranty for a good may become void if the consumer fails to perform adequate preventative maintenance on the good. Service providers, as they receive requests to repair, replace or otherwise service goods, can collect data related to the goods which can be used to remind the consumer of maintenance tasks to perform on the good, and as such, may be in a better position to remind the consumer of preventative maintenance tasks using the embodiments disclosed herein. By maintaining the good, the consumer can avoid a repair or replacement, thus avoiding hassle and delay associated with the repair or replacement, and the service provider can potentially save the expense of performing the repair or replacement.

Accordingly, the embodiments disclosed herein describe a system where line-item data from a transaction can be used to enroll a consumer in a service related to a product purchased in the transaction. In some embodiments, when the wireless device receives line-item transaction data during a purchase transaction, the wireless device can identify one or more services related to the purchase and automatically enroll the user of the wireless device for the service(s). For example, the wireless device can enroll the consumer in a manufacturer warranty program, an insurance program, and/or a maintenance and services program related to a good that was purchased in the transaction. In addition, consumer data can be used to register the consumer for the service. For example, the wireless device may store the name, address, telephone number, email address, or other information pertaining to the consumer which can be used to register the consumer in the service. In some embodiments, the wireless device can be configured to obtain consumer data from a remote computer system, such as a computer system associated with the issuer of one or more financial account cards of the user.

In some embodiments, the wireless device presents an offer for a service available to purchase that is related to a good that is purchased in a transaction. For example, when the wireless device is used in a purchase transaction for a good, a service related to the good (e.g., insurance, extended warranty, or maintenance and service programs) can be offered to the consumer using the wireless device. If the consumer would like to enroll in the service, financial account card data stored on the wireless device can be used to purchase the service.

Further, in some embodiments, once the consumer is enrolled in the service program, the wireless device can receive notifications alerting the consumer to events related to the service program. For example, the consumer can receive alerts to perform preventative maintenance or to bring the good to a service center to receive the benefit of the service program. According to some embodiments, a services data system can receive registration information which can include the identity of a good, the identity of the purchased service, and identification information associated with the consumer (e.g., a mobile device phone number, wireless device identifier, or email address). When an event related to the purchased service occurs, the services data system can generate an alert to provide to the mobile device associated with the consumer.

As a non-limiting example, one embodiment of the present disclosure is described in operation below. A consumer may have a wireless device, such as a mobile phone, that the consumer would like to use as an electronic wallet. The consumer can configure the wireless device as an electronic wallet by downloading one or more applications that allow the consumer to, among other things, store card data for the consumer's financial account cards in a memory associated with the wireless device. Once the application has been downloaded, the consumer can load the card data into the wireless device and subsequently use the card data for purchases. The consumer can also input consumer identification data, such as an address, phone number and/or email address. When the consumer uses the card data at a merchant location, such as Home Depot®, a POS terminal at the merchant location provides an electronic receipt to the wireless device. The wireless device can obtain line-item data such as the stock keeping unit (SKU) numbers of the products purchased in the transaction. The wireless device may then determine if a service related to the purchased product is available using the line-item data. The service could be, for example, a warranty for the purchased product, insurance for the purchased product, or maintenance plan associated with the purchased product. For example, if the user purchased a cordless drill, the drill manufacturer may offer a 1-year warranty that is part of the purchase price upon enrollment. The wireless device can use the consumer data and the line-item data to enroll the purchased good in the warranty program.

In addition to the 1-year warranty, Home Depot® may also offer an extended warranty for power tools for an additional cost. During or after the purchase transaction of the drill, the wireless device can receive information from the POS (or a remote computer system) that an extended warranty is available for the drill for $40. The wireless device can display a message to the consumer that the extended warranty is available for purchase. The consumer can agree to purchase the warranty, and the wireless device can use stored card data to purchase the warranty.

Once the consumer agrees to the extended warranty for the drill, the consumer can be enrolled in the warranty program. A services data system can determine one or more events related to the warranty program and send an alert to the consumer's wireless device. For example, the services data system can send periodic reminders to the consumer to oil the gear case or to replace the motor brushes of the drill. In addition, if the extended warranty includes replacement batteries, the service data system may send a reminder to the consumer's wireless device close to the expiration of the warranty reminding the consumer to take advantage of the warranty and request a replacement battery.

Reference will now be made to exemplary embodiments, examples of which are illustrated in the accompanying drawings. Wherever possible, the same reference numbers will be used throughout the drawings to refer to the same or like parts.

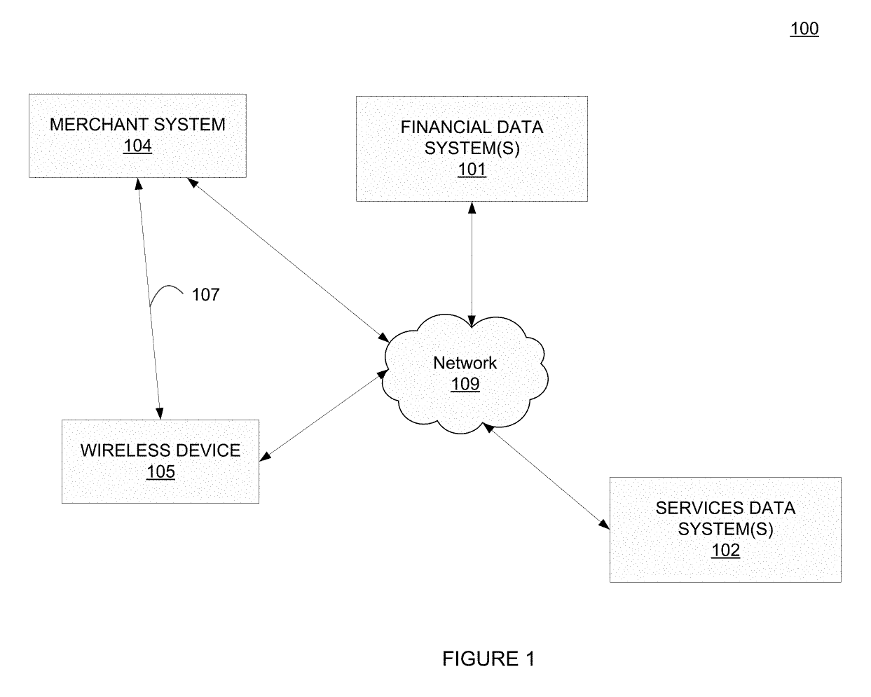

FIG. 1 shows a block diagram of an exemplary networked system 100 where a wireless device can communicate with one or more remote computing systems to perform operations consistent with the disclosed embodiments. In one embodiment, system 100 can include wireless device 105, one or more financial data system(s) 101, one or more services data system(s) 102, a merchant system 104, and a network 109. The components and arrangement of the components included in system 100 can vary. Thus, system 100 can include fewer or additional components that perform or assist in the performance of one or more processes consistent with the disclosed embodiments.

In some embodiments, components of system 100 can include one or more computing devices (e.g., computer(s), server(s), etc.), memory storing data and/or software instructions (e.g., database(s), memory devices, etc.), and other known computing components. The one or more computing devices can include one or more processors that can be configured to execute software instructions stored on one or more memory devices to perform one or more operations consistent with the disclosed embodiments. Components of system 100 can be configured to communicate with one or more other components of system 100 via network 109, or directly with each other via direct communication means. For example, wireless device 105 can communicate with merchant system 104 via direct communication link 107 which can include, near field communication (NFC), RFID, WiFi, Bluetooth, LiFi communication or any other wireless communication protocol known in the art, or wireless device 105 can communicate with merchant system 104 via network 109.

Financial data system(s) 101 can be a system or systems associated with financial service providers. Financial services providers can be a business entity that, among other things, provides financial account cards to consumers such as a bank, credit card issuer, or other entity that generates, provides, manages, and/or maintains financial service accounts for one or more users. Financial data system(s) 101 can generate, maintain, store, provide, and/or process financial data associated with one or more financial account cards. Financial data can include information about financial accounts including, but not limited to, issuing financial institution, card holder name, card holder address, account balance, available credit, existing fees, card expiration dates, and account transaction data (e.g., transaction dates, transaction amounts, transaction types, location of transaction, etc.).

In some embodiments, financial data system(s) 101 can provide account information to requesting computing systems, such as wireless device 105, for example. Financial data system(s) 101 can expose, in some embodiments, an application programming interface (API) that provides one or more methods for obtaining account information to requesting computing systems. For example, a requesting computing system (such as wireless device 105) can provide financial data system(s) 101 with a financial card account number via the API, and financial data system(s) 101 can provide the requesting computing system with the name, address, email address, expiration date, issuing bank, or other information associated with the financial card account number. The account information can be provided as a binary data stream, serialized data object, XML object, or in some other data form known to those with skill in the art.

Services data system(s) 102 can be one or more computing systems associated with one or more providers of services related to goods, such as a provider of warranties, insurance, or maintenance and services plans pertaining to goods. A services provider can be an entity that manufacturers a good, or an entity that partners with a manufacturer of a good to offer services related to that good. In some embodiments, services data system(s) 102 can include data systems owned, operated, or controlled by a merchant. Services data system(s) 102 can include, in some embodiments, one or more data stores or databases that link a product identifier, such as a stock keeping unit (SKU) number or inventory number, to a service related to that product. For example, services data system(s) 102 may include a database or datastore that links the SKU number of a computer made by a manufacturer named “SuperComputers” and purchased at a retailer named “Giant Electronics Store” to a manufacturer warranty from SuperComputers. In some embodiments, services data system(s) 102 can include a database or datastore that links a merchant identifier, such as a name, address, Merchant Category Code (MCC) or other merchant classifier, to one or more services. For example, services data system(s) 102 may include a database or datastore that links the name “Giant Electronics Store” with an extended warranty available from the store, or to a maintenance and service plan available from Giant Electronics Store. In some embodiments, services data system(s) 102 can expose an API that provides one or more methods for providing services information to a requesting computing system. For example, a requesting computing system (such as wireless device 105) can provide services data system(s) 102 with any combination of a product identifier, merchant identifier, and/or product type via the API and services data system(s) 102 can provide the requesting computer system with one or more services available for enrollment that satisfy the provided information.

In some embodiments, services data system(s) 102 can also include service registration data linking a consumer purchase to an enrolled service. For example, when a consumer purchases a service related to a good, the services data system(s) can receive registration data from wireless device 105. The registration data can include, for example, the name of the consumer, the consumer's address, the consumer's phone number, the consumer's wireless device identifier, the good, and the service plan related to the good.

According to some embodiments, services data system(s) 102 can collect historical service data related to servicing goods that are covered by the services. For example, if services data systems(s) 102 maintains data concerning a warranty for a computer, it can receive historical service data related to repairs or replacements of the computer or parts of the computer. Services data system(s) 102 can expose an API that allows external computing systems (not shown in FIG. 1) to provide the data. In some embodiments, services data system(s) 102 can request the historical service data from the external service data systems (not shown in FIG. 1). Services data systems(s) 102 can use the historical service data to create a list of one or more events related to the services for which it maintains data. The events can trigger alerts, messages, or event notifications to send to consumers based on the service registration data it receives.

Merchant system 104 may comprise one or more computing devices configured to perform one or more operations consistent with disclosed embodiments. For example, merchant system 104 can be a computing device that is controlled and operated by a merchant that provides products (e.g., goods and/or services), such as a retailer (e.g., Amazon.com®, Target®, etc.), grocery store, service provider (e.g., utility company, insurance company, financial service provider, automobile repair services, etc.), non-profit organization (ACLU™, AARP®, etc.) or any other type of entity that provides goods, services, and/or information that consumers (i.e., end-users or other business entities) can purchase, consume, use, etc. For ease of discussion, the present disclosure may describe exemplary embodiments in the context of purchase transactions involving goods from retail merchants, but merchant system 104 is not limited to systems associated with retail merchants that conduct business in any particular industry or field. According to some embodiments, merchant system 104 can be a mobile device (e.g., tablet, smart phone, etc.), a desktop computer, a laptop, a server or any other type of computing device. Merchant system 104 can also include a television, e-reader, or any other type of device capable of communicating with other components of system 100.

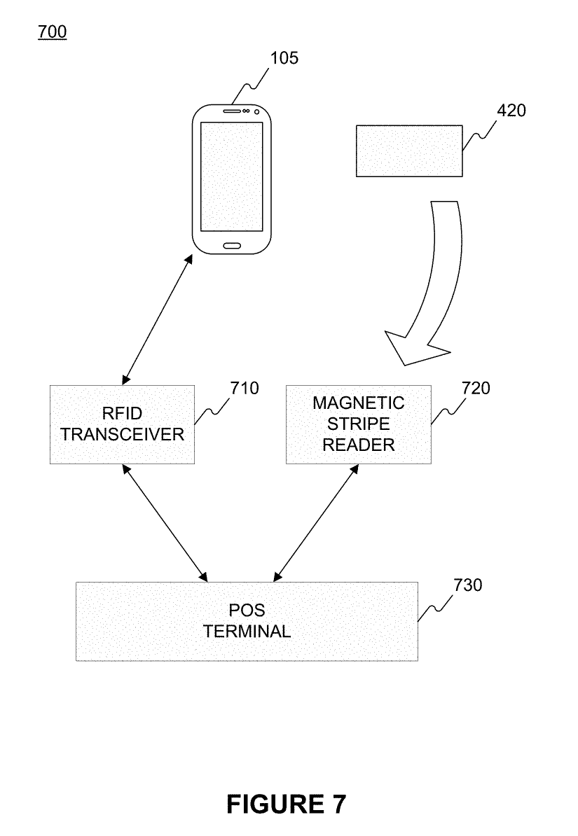

Merchant system 104 can include a POS terminal, which can be a dedicated POS terminal (e.g., POS Terminal 730 of FIG. 7, below), or a software application that can configure a general purpose computing device to accept financial account card payments. For example, the payment application can configure the general purpose computing device to interface with an input device connected to the general purpose computing system. The input device can include a terminal or port that accepts data financial account card data from wireless device 105.

In some embodiments, merchant system 104 can provide line-item data describing the items that are included in a given transaction. For example, if wireless device 105 is used to engage in a transaction with merchant system 104, merchant system 104 may provide an electronic receipt to wireless device 105. The electronic receipt could be in a standard data format such as a text file, PDF file, image file, or in another data format specific to packaging and transmitting line-item transaction data.

System 100 can also include, in some embodiments, wireless device 105. Wireless device 105 can be any consumer device configured for wireless communications consistent with the embodiments described herein. For example, wireless device 105 can include a mobile phone, personal digital assistant (PDA), tablet computing device, laptop computing device, smart card, or any other computing device configured to communicate wirelessly with one or more computing systems. In some embodiments, wireless device 105 can be configured to communicate wirelessly using Bluetooth, Wi-Fi, NFC, and cellular technologies such as CDMA, TDMA, LTE, GSM, for example.

Network 109 may be any type of network configured to provide communications between components of system 100. For example, network 109 can be any type of network (including infrastructure) that provides communications, exchanges information, and/or facilitates the exchange of information, such as the Internet, a Local Area Network, or other suitable connection(s) that enables the sending and receiving of information between the components of system 100. In other embodiments, one or more components of system 100 can communicate directly through one or more dedicated communication link(s), such as link 107.

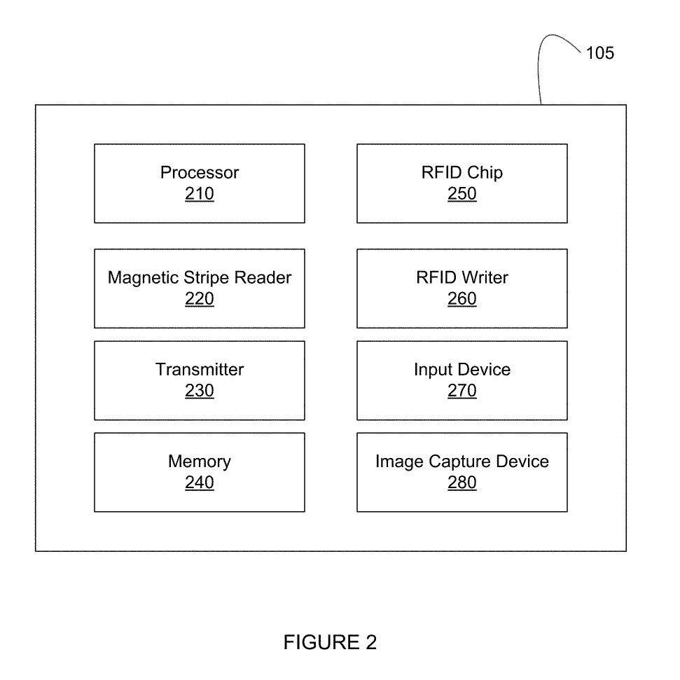

FIG. 2 shows a block diagram of the components of wireless device 105 according to one embodiment. For example, wireless device 105 may include a processor 210, a magnetic stripe reader 220, a transmitter 230, a memory 240, an RFID chip 250, an RFID writer 260, an input device 270, and/or an image capture device 280. Other components that may be included in wireless device 105 include a battery (not shown) for supplying power to transmitter 230 and RFID chip 250. Furthermore, wireless device 105 may include a sensor (not shown) for detecting the presence of a card. Still further, wireless device 105 may include a smart card reader (not shown) in addition to, or in place of, magnetic stripe reader 220. Wireless device 105 may also include a display, and in some cases a touch sensitive display.

In some embodiments, processor 210 may instruct magnetic stripe reader 220 to read card data from a card as it is inserted into wireless device 105. Alternatively, a smart card reader included in wireless device 105 may read data from the card. Further, card data that has been read from a card may be stored in memory 240 or may be written by RFID writer 260 to RFID chip 250. Transmitter 230 may be used in addition to RFID chip 250 to transmit card data and/or other data from wireless device 105. For example, transmitter 230 may be used to boost the signal strength of radio frequency signals sent from wireless device 105.

In some embodiments, card data from a card can be input to wireless device 105 using input device 270. For example, input device 270 can include a keypad or touchscreen configured to receive input from a user, and processor 210 may interpret data received by the input device 270 as card data which is stored in memory 240 or the RFID chip 250. Wireless device 105 may also capture card data from a card using image capture device 280 which can include a camera, optical sensor, infrared sensor or other sensor configured to capture an image. Once an image of a card is captured by image capture device 280, processor 210 can store the card data in memory 240 or write it to RFID Chip 250 using RFID writer 260.

In some embodiments, wireless device 105 can be used to purchase goods or services in a wireless transaction. During a transaction, a user may make a secured payment with wireless device 105. In such a transaction, card data stored on wireless device 105 may be transmitted by, for example, RFID chip 250 to a nearby RFID reader associated with a merchant, such as merchant system 104. As wireless device 105 may be capable of storing card data for one or more financial account cards, wireless device 105 can also act as an electronic wallet.

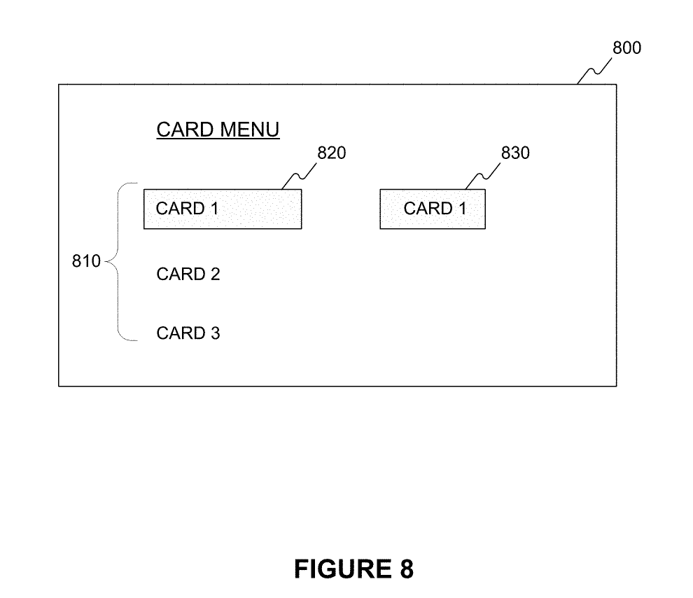

A user of wireless device 105 may also store data for multiple cards by providing a first card to wireless device 105 so that the device may store the card data from the first card in memory 240. The user may then provide a second card to wireless device 105 which is also stored in memory 240. After a user has stored card data for more than one card in wireless device 105, the user may select a card from a menu screen shown on a display of wireless device 105, such as the menu screen shown in FIG. 8 and described in further detail below. In some embodiments, wireless device 105 may suggest a stored card or default the selection of the card on displayed menu based on user preferences, data describing the transaction for which the card will be used, or based on an offer presented by wireless device 105 consistent with embodiments disclosed herein.

Wireless device 105 may also include security features that authorize a transaction. For example, a security validation may be required for transactions to prevent unauthorized use of card data stored in memory 240. Further, card data may be encrypted using encryption techniques so that transmitted card data cannot be intercepted in an accessible form.

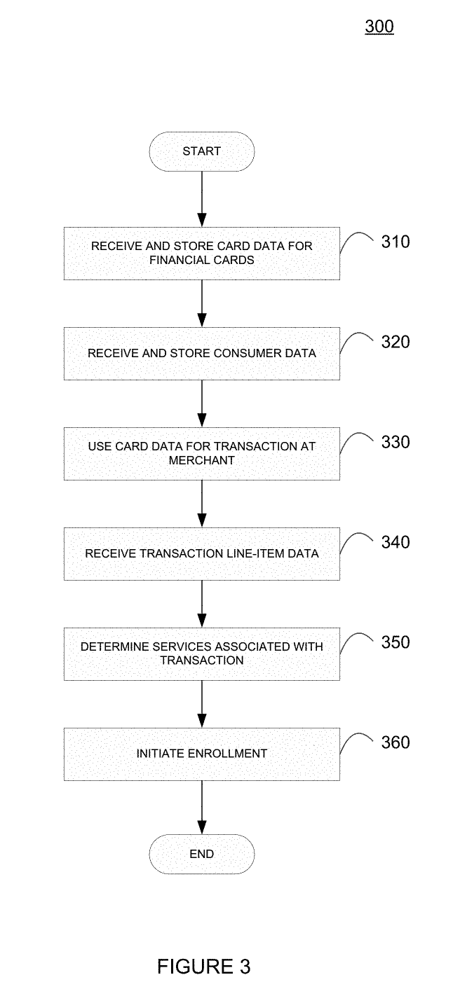

FIG. 3 shows an exemplary flow diagram of a process 300 for services enrollment using a wireless device, such as wireless device 105. As described in more detail below, process 300 can be performed by wireless device 105 to enroll a consumer for services related to a purchased good based on line-item data received from a merchant (e.g., merchant system 104) during a purchase transaction of the good. The services related to the purchased good can include a manufacturer warranty, a warranty provided by the merchant, insurance for the good, a service or maintenance plan related to the good, or any other service that relates to the good. The services can be included with the purchase, or can be offered to the consumer for an additional fee.

Process 300 begins when wireless device 105 receives card data for one or more financial account cards (Step 310). In some embodiments, wireless device 105 receives the card data via a card reader that is part of wireless device 105 or attached as a peripheral to wireless device 105 consistent with present embodiments. According to some embodiments, wireless device 105 receives the card data via one of its associated input/output devices such as a touchscreen, keypad, or camera. For example, a user of wireless device 105 may manually enter an account number associated with the financial card, or the user may take a picture of the card with a camera included in or in communication with wireless device 105, and OCR capable software installed on wireless device 105 may extract the card data. In some embodiments, wireless device 105 may communicate with one or more remote computer systems to obtain additional card data that is not stored directly on a financial account card. For example, wireless device 105 may communicate with one or more remote computer systems to obtain the identity of the financial institution that issued the financial account card, branding associated with the card, the name and address of the account holder of financial account card, etc.

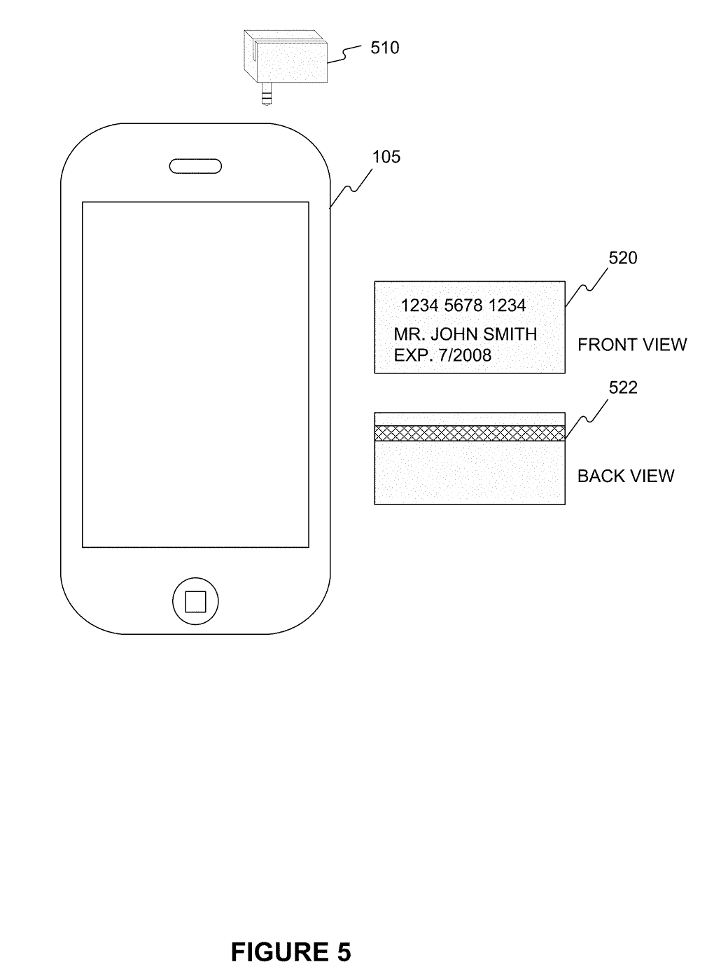

In some embodiments, wireless device 105 may receive the card data through a dedicated card reader attached to, or part of, wireless device 105 as shown in FIG. 5. FIG. 5 shows an embodiment of wireless device 105 including a card reader 510 for inserting a card 520. According to the example shown in FIG. 5, wireless device 105 is preferably a mobile phone. However, wireless device 105 may be a PDA, or other handheld device, such as a Blackberry. Although wireless device 105 shows card reader 510 as a peripheral attachment to the device, card reader 510 may be incorporated into the wireless device 105, for example, as a card reader on one side of wireless device 105. In exemplary embodiments, card reader 510 may include a magnetic strip reader (not shown) for reading card data on card 520. Further, in some embodiments, wireless device 105 may not include card reader 510 and instead can receive card data via input devices such as a touchscreen, keypad, or camera. For example, a user of wireless device 105 may manually enter an account number associated with the financial card, or the user may take a picture of the card with wireless device's 105 camera, and OCR capable software installed on wireless device 105 may extract the card data.

Card 520 may be a financial account card, such as a credit card, a debit card, a smart card, an ATM card, or any other card associated with a financial account and that may be used to make purchase transactions. Card 520 includes, for example, account information, such as information identifying the card holder, an account number, and expiration date. Further, as shown in FIG. 5, according to the back view of card 520, card 520 includes magnetic stripe 522. In the case of a smart card, card 520 will include a smart card chip (not shown), which may be read by a smart card reader included in wireless device 105 in addition to, or instead of, a reader to read magnetic stripe 522.

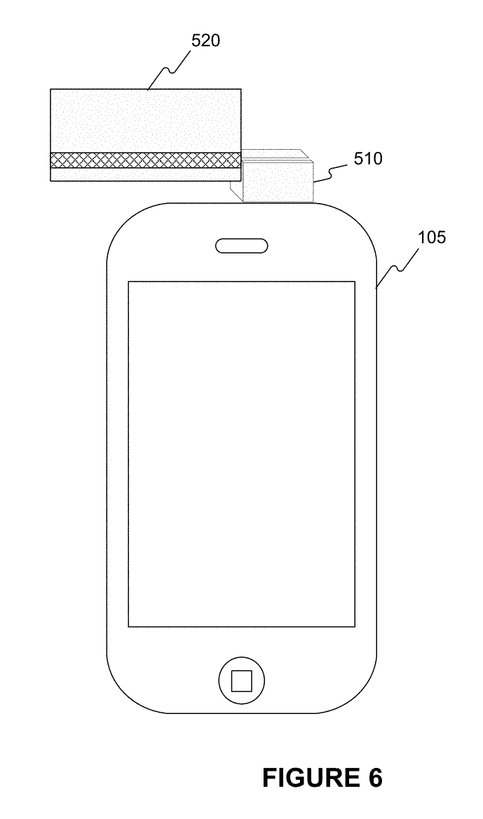

FIG. 6 shows card 520 being inserted into card reader 510 of wireless device 105. When card 520 is inserted into card reader 510 of wireless device 105, a magnetic stripe reader (not shown) may read card data stored on a magnetic stripe. Alternatively, card 520 may include a smart card chip, which may be reader by a smart card reader (not shown) included in wireless device 105. Card data may be stored in a memory of wireless device 105 (e.g., memory 240) or may be used to program an RFID chip included in wireless device 105 (e.g. RFID Chip 250).

Returning to FIG. 3, once wireless device 105 receives the card data, it can store the card data in memory (Step 310) associated with wireless device 105. In some embodiments, wireless device 105 may store the card data in a local memory (e.g., memory 240), or program a RFID chip of wireless device 105 (e.g., (e.g. RFID Chip 250). According to some embodiments, wireless device 105 can store the card data in remote memory accessible by wireless device 105. For example, the card data can be stored via a cloud computing service to a cloud-based storage device.

According to some embodiments, wireless device 105 can also receive consumer data (Step 320). Consumer data can include the consumer's name, mailing address, phone number, and/or email address. Wireless device 105 can receive the consumer data via its input device, such as its keyboard, virtual keyboard, touchscreen, camera (e.g., via image capture and OCR), speech input, or any other input means known in the art. In some embodiments, wireless device 105 obtains consumer data from a remote computer system, such as financial data system(s) 101. For example, after wireless device 105 receives card data for a financial account card, it can query the financial data system 101 to obtain the account holder's name, address, email address, phone number, or other identification information that financial data system 101 may store in its data store or database. Once wireless device 105 receives the consumer data, it can store it in memory (Step 320) associated with wireless device 105. In some embodiments, wireless device 105 may store the consumer data in a local memory (e.g., memory 240). According to some embodiments, wireless device 105 can store the consumer data in remote memory accessible by wireless device 105. For example, the consumer data can be stored via a cloud computing service to a cloud based storage device.

Once the card data is stored, a user of wireless device 105 may use the card data in a transaction at a merchant (Step 330). According to some embodiments, wireless device 105 can be configured to communicate with a computing system of a merchant (e.g., merchant system 104). The computing system of the merchant may include a POS terminal. FIG. 7 shows one embodiment of wireless device 105 communicating with POS terminal 730, which may, in some embodiments, be part of a computing system of a merchant (e.g., merchant system 104). FIG. 7 shows an exemplary diagram 700 of an interaction between wireless device 105, an RFID transceiver 710, and a magnetic stripe reader 720, according to some embodiments. RFID transceiver 710 and magnetic stripe reader 720 may be connected to POS terminal 730, or be part of POS terminal 730. POS terminal 730 receives data from RFID transceiver 710 and/or magnetic stripe reader 720 to process a transaction. A merchant may use POS terminal 730 to input data describing a purchase and to verify payment information obtained by RFID transceiver 710 and/or magnetic stripe reader 720.

Once POS terminal 730 has received payment information, such as account information for a credit card, POS terminal 730 may transmit the payment information in a secure format over a network (not shown) in a process that is consistent with a typical purchase transaction, such as that involving a credit card. In such a credit card transaction, for example, once an external server (not shown) verifies and approves the credit card transaction, authorization for the transaction may be sent over the network to POS terminal 730.

As shown in FIG. 7, wireless device 105 may also transmit card data by radio frequency to RFID transceiver 710. In such a situation, a user will hold wireless device 105 near RFID transceiver 710 at, for example, the direction of the merchant or after being prompted by a message shown on a display (not shown) of RFID transceiver 710 requesting the user to provide payment information. Although FIG. 7 shows POS terminal 730 as including RFID transceiver 710 to receive card data from wireless device 105 via wireless communication, in other embodiments, POS terminal 730 can include additional or alternative readers configured to receive wireless data. For example, POS terminal 730 can include a Bluetooth, WiFi, NFC, RF or other transceiver capable of receiving wireless communications.

In some embodiments, wireless device 105 may have stored in its associated memory more than one financial account card requiring a selection of a card for use in a transaction. Accordingly, in some embodiments, wireless device 105 may generate a user interface on its display to facilitate the selection of stored card data for the transaction. FIG. 8 shows an exemplary display 800 of wireless device 105, which may include a menu 810 of financial cards for which wireless device 105 has stored card data. As shown in FIG. 8, menu 810 may include a list of three cards designated as card 1, card 2, and card 3. Further, card 1 is shown as having been selected by selection box 820. Selection box 820 may be, for example, a highlighted border surrounding a selected item shown on display 800. A user may make a selection from menu 810 by using input keys (not shown) of wireless device 105, or by touching display 800. Furthermore, as shown in the exemplary embodiment of FIG. 8, card 1 may also be represented by image 830, which shows a graphical image of a card. Alternatively, card 1 may be selected for use in making a purchase by selecting image 830 using input keys or by touching display 800. Image 830 may be an image of a credit card, a logo, text, or any graphical image that the user has associated with card 1.

For example, a user may access menu 810 on wireless device 105. As shown in FIG. 8, menu 810 displays one or more cards that have card data stored in wireless device 105. The user may select a card, such as card 1, by using input keys, for example, from menu 810. Alternatively, the user may select card 1 by selecting image 830. Thereafter, the user may use wireless device 105 to make a purchase with card 1. A user may therefore make selections from menu 810 to select a particular card for a transaction.

In some embodiments, the use of a particular financial account card in a transaction can affect the services that are available for enrollment. For example, one credit card issuer might offer a one year extended warranty on electronics purchased with the card, or the credit card issuer might offer insurance for kitchen products purchased with the card. According to some embodiments, wireless device 105 can automatically select a particular financial account card based on available services. For example, wireless device 105 can receive line-item transaction data, the MCC of the current merchant, or other information identifying the type of goods being purchased in the transaction. Once received, wireless device 105 can make a request to the financial data system(s) 101 or services data system(s) 102 associated with the sets of card data stored on it, and determine if there are any services available for the use of the card during the transaction. If wireless device 105 determines that the use of a particular financial card provides an opportunity for services enrollment, wireless device 105 can display card menu 810 and select the card offering the service by default. For example, a consumer may use wireless device 105, which has card 1, card 2, and card 3 stored on it, for a purchase transaction at a sporting goods store. During the transaction, the merchant system can transmit the MCC applying to sporting goods stores to wireless device 105. Wireless device 105 can determine that card 2 offers an extended warranty on sporting goods purchases by, for example, sending the MCC to the financial data system(s) or services data system(s) associated with card 1, card 2 and card 3, and receiving a response indicating that card 2 offers the warranty. Wireless device 105 can then display card menu 810 and automatically select card 2 by default. In some embodiments, the consumer can confirm the automatic selection.

In some embodiments, security features, such as authorization, may be used to determine whether a transaction may proceed with a selected card. For example, in some embodiments, a security code may be required before a selected card may be used to make a transaction. When a user selects the card for making a purchase, a prompt may require the user to enter a security code to authorize use of the card data. Once entered, wireless device 105 may determine whether the correct security code has been entered by comparing the entered code with a code stored in memory 240 of wireless device 105. For example, the security code may be stored in an encrypted form in wireless device 105. After validating the security code, wireless device authorizes the use of the card data and wireless device 105 transmits the card data from wireless device 105 to the POS terminal. For example, card data may be transmitted from wireless device 105 to a nearby RFID reader. The RFID reader may be included in and/or connected to a POS terminal, as shown in FIG. 7. Further, the security code may be entered by the user via input keys on wireless device 105. Alternatively, the security code may be entered by the user at the POS terminal and transmitted over a network to an external server for validation. The security code may be a personal identification number (PIN). In other embodiments, instead of a security code, authorization may be provided by a fingerprint, voice print, or retinal scan of the user. Also, in any of the above embodiments, the security code may be received by wireless device 105 or by a POS terminal.

Returning to FIG. 3, during or after the transaction, wireless device 105 may receive line-item data for the purchase transaction (Step 340). The line-item data may be received by wireless device 105 as an electronic receipt, for example. The line-item data can include a text description of the goods or services purchased during the transaction, a SKU number for the goods or services, and/or the price of the goods or services. According to some embodiments, the SKU number for the good can be obtained by an RFID tag that has been attached to the good, or from a taking an image captured by wireless device 105. In such embodiments, wireless device 105 may prompt the consumer to obtain the SKU number for the good using the RFID tag (e.g., for wireless devices configured with NFC technology) or by capturing an image of the universal product code (UPC) or other unique identifier associated with the good. Once captured, the wireless device 105 can associate the captured product identifier with the line-item data.

In some embodiments, wireless device 105 will determine services associated with the transaction (Step 350), for which the consumer is eligible for enrollment. The services can include, for example, a warranty for a good purchased in the transaction, insurance that is available for the good purchased or a maintenance or service program that is available with respect to the good. According to some embodiments, wireless device 105 determines the services that are available by sending the line-item transaction data to a remote computer system (e.g., services data system(s)\ 102), and the remote computer system may provide an indication of available services. In some embodiments, wireless device 105 additionally sends consumer data to services data system(s) 102 with the line-item transaction data to initiate automatic services enrollment (step 360). For example, if a consumer purchases a television with card data stored on wireless device 105, wireless device 105 may receive line-item transaction data describing the television. Wireless device 105 may then send the line-item transaction data and consumer data (obtained in step 320) to a services data system(s) 102. Once services data system(s) 102 receives the line-item data and the consumer data it can automatically enroll the consumer and the television in a warranty program, if available.

In some embodiments, wireless device 105 may receive a list of available services for a purchased item in response to providing line-item transaction data. For example, wireless device 105 may communicate line-item transaction data to services data system(s) 102, and services data system(s) 102 may provide one or more services that are available for enrollment for the purchased item. Once wireless device 105 receives the list of one or more services, it can provide the list (e.g., via a user interface) to the consumer to allow the consumer to select the services in which she is interested in enrolling. When wireless device 105 receives the selection from the consumer, wireless device 105 may initiate services enrollment (step 360) by sending consumer data to services data system(s) 102. Wireless device 105 can also determine services associated with the transaction by receiving services information from merchant system 104. For example, merchant system 104 can provide one or more services available for enrollment during the transaction or at the end of the transaction. In such embodiments, wireless device 105 can initiate services enrollment (step 360) by providing consumer data to merchant system 104.

In some embodiments, the services available for enrollment may be available for fee. For example, when a consumer purchases a television, the merchant selling the television may offer an extended warranty covering the television for an additional year past the manufacturer warranty for a cost of $20. In such embodiments, merchant system 104 can provide information regarding the services available for purchase to wireless device 105. Wireless device 105 can display information regarding the services available for purchase, thereby providing the consumer the opportunity to provide input indicating a desire to purchase the service. When wireless device 105 receives input indicating that the consumer would like to enroll in, and purchase, the service, wireless device 105 can initiate payment for the service. For example, wireless device 105 can transmit card data to merchant system 104 to initiate payment for the service. Once wireless device 105 initiates payment, it can also initiate enrollment by sending consumer data to merchant system 104 or services data system(s) 102.

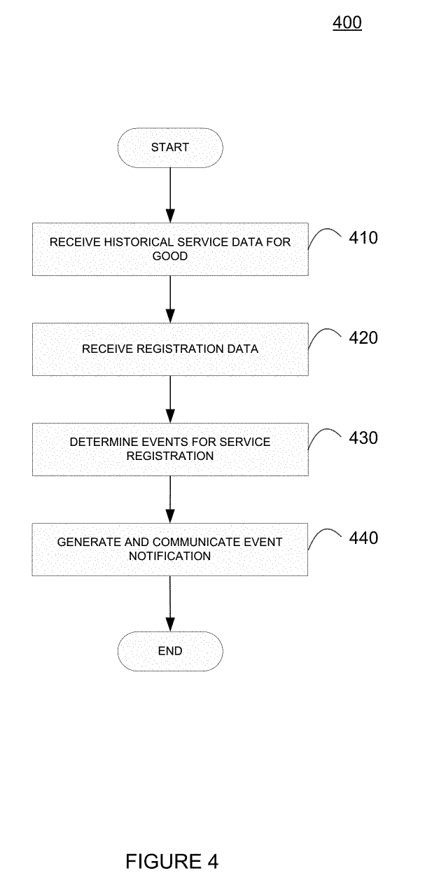

FIG. 4 shows an exemplary flow diagram of a process 400 for event notification to notify a computing device, such as wireless device 105, of events related to a service. As described in more detail below, process 400 can be performed by services data system(s) 102 to alert a consumer regarding events associated with services related to a purchased good based on historical service data and/or registration data. The events can include periodic maintenance reminders related to the good for which the service applies or events that are related to the service itself, such as the beginning or end of the service or a benefit related to the service. The event notifications can be included with the purchase of the service, or it can be offered to consumers for an additional fee.

Process 400 begins when, for example, service data system(s) 102 receives historical service data for a good (step 410). In some embodiments, as service providers perform actions related to services, the actions can be sent to service data system(s) 102 for the purposes of determining events for a service offering (step 420). The historical service data can include, among other things, a product identifier that identifies the good associated with the service, the date the service was performed, the length of time from when the good was sold or manufactured to the service date, and any preventative maintenance that could have prevented the repair. For example, if a service relates to a washing machine that was purchased on Apr. 1, 2010, and the washing machine's drainage pump was replaced under a warranty on Apr. 1, 2014, the service data system(s) 102 may receive historical service data including the model number of the washing machine, part number of the drainage pump, and four years as the length of time from purchase to service. In addition, the historical service data can also include notes related to the service, such as a note that the drainage pump had rusted due to the washing machine being installed outdoors.

According to some embodiments, service data system(s) 102 receives registration data (step 420). The registration data can include, for example, the name of the consumer, the consumer's address, the consumer's phone number, the consumer's wireless device identifier, the good, and the identification of the service plan related to the good. The service data system(s) 102 can use the registration data to generate event notifications (at step 440) for consumers. For example, the service data system(s) 102 can send an email notification to a consumer's email address or a push notification to the consumer's wireless device using the registration data it receives from the consumer's wireless device or other computing device.

Once service data system(s) 102 receives the historical data for the good and the registration data, it can determine one or more events for the service related to the good (step 430). For example, if the historical data indicates that a repair is common two years after purchase, the service data system(s) 102 can determine an event for the consumer to check the parts related to the repair two years after purchase. In some embodiments, the events can also be related to the service itself, as opposed to the historical service data, such as when the service plan includes periodic replacement parts. For example, if the service relates to a printer, and the service plan provides for replacement ink cartridges every three months, the service data system can generate events to send a consumer every three months once the consumer registers for the service and service data system(s) 102 receives the registration data (at step 430). The determined events can include, but are not limited to, the beginning of a service period, the ending of a service period, periodic reminders to obtain the service, routine maintenance performed by a technician pursuant to the service plan, a benefit available under the service plan, or preventative maintenance that the consumer can perform.

After the service data system(s) 102 determines the events for a service registration, it can generate event notifications as needed for the events (step 440). Once generated, the event notifications can be sent to the consumer using the registration data received by the service data system(s) 102 (e.g., at step 420). The service data system(s) 102 can, for example, generate an email notification and send it to the consumer's email address. In some embodiments, the service data system(s) 102 can generate a text message, short message service message, or multimedia message which is sent to wireless device 105 of the consumer.

The foregoing descriptions have been presented for purposes of illustration and description. They are not exhaustive and do not limit the present embodiments to the precise form disclosed. Modifications and variations are possible in light of the above teachings or may be acquired from practicing of embodiments. For example, the described implementation includes software but other embodiments may be implemented as a combination of hardware and software or in hardware alone. For example, the described implementations include hardware and software, but systems and methods consistent with the present disclosure can be implemented as hardware alone. Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM.

Computer programs based on the written description and methods of this specification are within the skill of a software developer. The various programs or program modules can be created using a variety of programming techniques. For example, program sections or program modules can be designed in or by means of Java, C, C++, assembly language, or any such programming languages. One or more of such software sections or modules can be integrated into a computer system, computer-readable media, or existing communications software.

Other embodiments will be apparent to those skilled in the art from consideration of the specification and practice of the embodiments disclosed herein. The specification and examples should be considered as exemplary only.

1-21. (canceled)

22. A method for alerting a customer about events associated with services related to purchased goods, the method comprising:
receiving line-item data in response to a user using a wireless device to perform a transaction at a merchant computing system, the wireless device configured to store card data associated with a financial account and to transmit the card data to the merchant computer system to perform the transaction;
determining service data associated with a good based on the line-item data, the service data comprising a product identifier associated with the good;
receiving, via the input of the wireless device, registration data associated with the user, the registration data comprising an identification of a service plan related to the good and a wireless identifier associated with the wireless device;
determining an event related to the good based on the service data and the registration data;
generating one or more event notifications associated with the event; and
transmitting, to the wireless device, the one or more event notifications based on the wireless identifier.

23. The method of claim 22, wherein the service data further comprises at least one of a service performance date, a length of time from when the good was sold to the service performance date, a length of time from when the good was manufactured to the service performance date, or a preventative measure.

24. The method of claim 22, wherein the registration data is received via a financial data system associated with an issuer of the financial account card used to perform the transaction.

25. The method of claim 22, wherein the registration data associated with the user further comprises at least one of a name of the user, an address associated with the user, a phone number associated with the user, a communication method associated with the user, or a product identifier associated with the good.

26. The method of claim 25, wherein the communication method associated with the customer comprises at least one of text, e-mail, instant message, voice, or audio.

27. The method of claim 22, wherein the event is associated with at least one of a beginning of a service period, an ending of the service period, a periodic reminder to obtain service, a routine maintenance pursuant to the service plan, a preventative measure, or a benefit available under the service plan.

28. The method of claim 27, wherein the one or more event notifications are generated periodically based on the service plan related to the good being periodic.

29. A system for alerting a customer about events associated with services related to purchased goods, the system comprising:
one or more memory devices storing software instructions; and
one or more processors configured to execute the software instructions to:
receive line-item data in response to a user using a wireless device to perform a transaction at a merchant computing system, the wireless device configured to store card data associated with a financial account and to transmit the card data to the merchant computer system to perform the transaction;
determine service data associated with a good based on the line-item data, the service data comprising a product identifier associated with the good;
receive, via the input of the wireless device, registration data associated with the user, the registration data comprising an identification of a service plan related to the good and a wireless identifier associated with the wireless device;
determine an event related to the good based on the service data and the registration data;
generate one or more event notifications associated with the event; and
transmit, to the wireless device, the one or more event notifications based on the wireless identifier.

30. The system of claim 29, wherein the service data further comprises at least one of a service performance date, a length of time from when the good was sold to the service performance date, a length of time from when the good was manufactured to the service performance date, or a preventative measure.

31. The system of claim 29, wherein the registration data is received via a financial data system associated with an issuer of the financial account card used to perform the transaction.

32. The system of claim 29, wherein the registration data associated with the user further comprises at least one of a name of the user, an address associated with the user, a phone number associated with the user, a communication method associated with the user, or a product identifier associated with the good.

33. The system of claim 32, wherein the communication method associated with the customer comprises at least one of text, e-mail, instant message, voice, or audio.

34. The system of claim 29, wherein the event is associated with at least one of a beginning of a service period, an ending of the service period, a periodic reminder to obtain service, a routine maintenance pursuant to the service plan, a preventative measure, or a benefit available under the service plan.

35. The system of claim 34, wherein the one or more event notifications are generated periodically based on the service plan related to the good being periodic.

36. A non-transitory computer readable medium storing instructions that, when executed by one or more processors, cause the one or more processors to perform operations for alerting a customer about events associated with services related to purchased goods, the operations comprising:
receiving line-item data in response to a user using a wireless device to perform a transaction at a merchant computing system, the wireless device configured to store card data associated with a financial account and to transmit the card data to the merchant computer system to perform the transaction;
determining service data associated with a good based on the line-item data, the service data comprising a product identifier associated with the good;
receiving, via the input of the wireless device, registration data associated with the user, the registration data comprising an identification of a service plan related to the good and a wireless identifier associated with the wireless device;
determining an event related to the good based on the service data and the registration data;
generating one or more event notifications associated with the event; and
transmitting, to the wireless device, the one or more event notifications based on the wireless identifier.

37. The non-transitory computer readable medium of claim 36, wherein the service data further comprises at least one of a service performance date, a length of time from when the good was sold to the service performance date, a length of time from when the good was manufactured to the service performance date, or a preventative measure.

38. The non-transitory computer readable medium of claim 36, wherein the registration data is received via a financial data system associated with an issuer of the financial account card used to perform the transaction.

39. The non-transitory computer readable medium of claim 36, wherein the registration data associated with the user further comprises at least one of a name of the user, an address associated with the user, a phone number associated with the user, a communication method associated with the user, or a product identifier associated with the good.

40. The non-transitory computer readable medium of claim 39, wherein the communication method associated with the customer comprises at least one of text, e-mail, instant message, voice, or audio.

41. The non-transitory computer readable medium of claim 36, wherein the event is associated with at least one of a beginning of a service period, an ending of the service period, a periodic reminder to obtain service, a routine maintenance pursuant to the service plan, a preventative measure, or a benefit available under the service plan.
